(19) United States
(12) Patent Application Publication
(10) Pub. No.: US 2020/0401660 A1
(43) Pub. Date: Dec. 24, 2020

(54) SEMANTIC SPACE SCANNING FOR DIFFERENTIAL TOPIC EXTRACTION

(71) Applicant: Microsoft Technology Licensing, LLC, Redmond, WA (US)

(72) Inventors: Alexander James WILSON, Dublin (IE); Romain REY, Tourrettes sur loup (FR)

(21) Appl. No.: 16/444,638

(22) Filed: Jun. 18, 2019

(51) Int. Cl. G06F 17/27

(52) U.S. Cl. CPC G06F 17/2785; G06F 17/277; G06F 17/2715

(57) ABSTRACT

A system for extracting differential topics from a dataset including a user interface, a memory for storing executable program code, and one or more electronic processors coupled to the memory and the user interface. The electronics processors are configured to receive a dataset from one or more servers, wherein the dataset comprises user feedback data associated with a software program. The electronic processors are also configured to extract text from the dataset, convert the extracted text to vector data, and determine anomalous data clusters associated with the vector data using statistical analysis. The electronic processors are also configured to differentiate overlapping anomalous data clusters using a classification algorithm, wherein the differentiated overlapping anomalous data clusters are associated with specific topics, and export each specific topic associated with the differentiated overlapping data cluster.

### FIELD

Embodiments described herein relate to tools to assist software developers in identifying, assessing, and remedying performance deficiencies in software used in varied geographical regions.

### SUMMARY

Software has become both more complex and commonplace. Software packages may be configured to work in multiple geographical regions throughout the world. This can require modifications to aspects of a software package for use in different regions. For example, text types, languages, and the like may all be required to be modified for different regions in which the software will be used. In some instances, these variations in the software can cause users in some regions to experience issues that may not be as prevalent in other regions. Users of the software may provide service data in various ways which can then be analyzed to determine what issues are experienced by users of the software. However, it can be difficult to parse out data from different regions, or other categories. Difficulties in parsing data by region, can make it difficult for developers to understand different issues affecting different users in different regions. Ease in analysis would allow a developer or team to quickly identify specific issues experienced in a particular region that are different from issues experienced by users in other regions and/or different from general user issues. Providing a tool to assist the analysis would facilitate developers' ability to address regional, or specific subgroup, issues in a more timely fashion. Thus, systems and methods for determining differential datasets, are described herein.

For example, one embodiment provides a system for extracting differential topics from a dataset. The system includes a user interface, a memory for storing executable program code, and one or more electronic processors coupled to the memory and the user interface. The electronics processors are configured to receive a dataset from one or more servers, wherein the dataset comprises user feedback data associated with a software program. The electronic processors are also configured to extract text from the dataset, convert the extracted text to vector data, and determine anomalous data clusters associated with the vector data using statistical analysis. The electronic processors are also configured to differentiate overlapping anomalous data clusters using a classification algorithm, wherein the differentiated overlapping anomalous data clusters are associated with specific topics, and export each specific topic associated with the differentiated overlapping data cluster.

Another embodiment provides a method for extracting differential topics from a dataset. The method includes receiving, at a computing device, a dataset form one or more servers, wherein the dataset comprises user feedback data associated with a software program. The method also include extracting text from the dataset and converting the extracted text to vector data within a high-dimensional vector space via the computing device. The method also includes determining anomalous data clusters associated with the vector data using statistical analysis, and differentiating overlapping anomalous data clusters using a classification algorithm, via the computing device. The differentiated overlapping anomalous data clusters are associated with specific topics within the user feedback data. The method also includes exporting each specific topic associated with the differentiated overlapping data clusters via the computing device.

Another embodiment provides a system for extracting geographically differential topics from a dataset, the system includes a user interface, a memory for storing executable program code, and one or more electronic processors coupled to the memory and the user interface. The electronic processors are configured to receive a dataset from one or more servers, wherein the dataset comprises user feedback data associated with a software program. The electronic processors are also configured to execute a differential topic extraction algorithm to isolate relevant text within the dataset, and extract text from the dataset. The electronic processors are also configured to convert extracted text to vector data by executing a distributional semantics modeling algorithm and map the vector data in a high-dimensional space. The electronic processors are also configured to determine anomalous data clusters associated with the vector data using a Bayesian scan statistics statistical analysis. The electronic processors are also configured to differentiated overlapping anomalous data clusters using a classification algorithm, wherein the differentiated overlapping anomalous data clusters are associated with specific topics, and export each specific topic associated with the differentiated overlapping data clusters.

These and other features, aspects, and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a block diagram of a computing device, according to some embodiments.

FIG. 2 is a flow chart illustrating a process for performing differential topic extraction, according to some embodiments.

FIG. 3 is an illustration of an example of vector data in high-dimensional space, according to some embodiments.

FIG. 4 is an illustration of anomalous regions within a dataset in the high-dimensional space of FIG. 3, according to some embodiments.

FIG. 5 is an illustration of a specific anomalous region within the high-dimensional space of FIG. 3, according to some embodiments.

FIG. 6 is an illustration of an example output display, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. In addition, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Relational terms such as first and second, top and bottom, and the like may be used herein solely to distinguish one entity or action from another entity or action without necessarily requiring or implying any actual such relationship or order between such entities or actions.

Software companies may receive a large amount of user feedback regarding the use of their software products. In some cases, the data may come from users all around the globe, which can result in issues being reported that are unique to users in specific regions. Example issues include performance deficiencies or other user identified defects or functional problems with a software product. Due to the large amount of feedback data received, and the potential for overlap between common issues seen in all regions, it may be difficult to extract and/or determine feedback data that is specific to a region. For example, while there may be substantial overlap in issues for the English version of a software package and a Japanese version of a software package, there may also be specific issues that relate to each version, and the users thereof. The technology described herein is configured to extract differential topics from datasets. The differential topics may be based on different geographical regions, or based on other differential aspects, such as location of users, types of users, different market segments, political affiliation of users, different products used by users, and the like. Thus, it should be understood that the below embodiments are not limited to analyzing data from different geographical regions, but rather can analyze data of any type to attempt to extract differential topics.

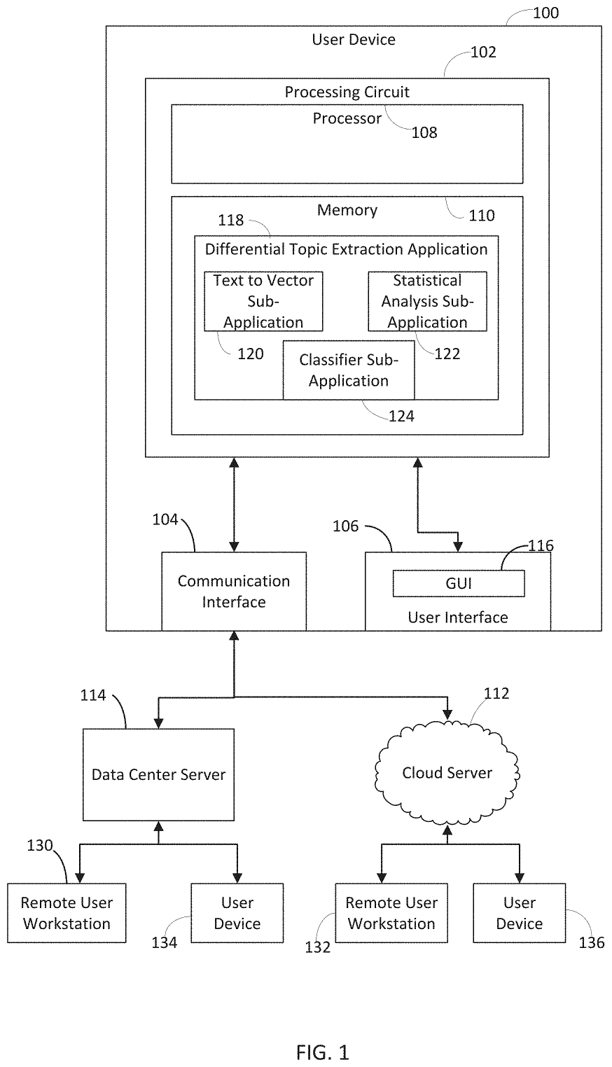

Turning now to FIG. 1, a block diagram of an example computing device 100 is shown, according to some embodiments. The computing device 100 may be a personal computer, a laptop computer, a tablet computer, a mobile device (for example, a smartphone, a dedicated-purpose computing device, etc.). As shown in FIG. 1, the computing device 100 includes a processing circuit 102, a communication interface 104, and a user interface 106. The processing circuit 102 includes an electronic processor 108 and a memory 110. The processing circuit 102 may be communicably connected to one or more of the communication interface 104 and the user interface 106. The electronic processor 108 may be implemented as a programmable microprocessor, an application specific integrated circuit (ASIC), one or more field programmable gate arrays (FPGA), a group of processing components, or with other suitable electronic processing components.

The memory 110 (for example, a non-transitory, computer-readable medium) includes one or more devices (for example, RAM, ROM, Flash memory, hard disk storage, etc.) for storing data and/or computer code for completing or facilitating the various processes, layers, and modules described herein. The memory 110 may include database components, object code components, script components, or other types of code and information for supporting the various activities and information structure described in the present application. According to one example, the memory 110 is communicably connected to the electronic processor 108 via the processing circuit 102 and may include computer code for executing (for example, by the processing circuit 102 and/or the electronic processor 108) one or more processes described herein.

The communication interface 104 is configured to facilitate communication between the computing device 100 and one or more external devices or systems, for example, those shown in FIG. 1. The communication interface 104 may be or include wireless communication interfaces (for example, antennas, transmitters, receivers, transceivers, etc.) for conducting data communications between the computing device 100 and one or more external devices, for example, a cloud based server 112, one or more data center servers 114, or other remote services. In some embodiments, the communication interface 104 utilizes one or more wireless communication protocols. The communication interface 104 may additionally be or include wired communication interfaces to facilitate wired communication between the computing device 100 and one or more other devices, for example, those described in FIG. 1.

The user interface 106 may allow for a user to provide inputs to the computing device 100. For example, the user interface 106 may include a keyboard, a mouse, a trackpad, a touchscreen (for example, resistive, capacitive, inductive, etc.), or other known input mechanism. The user interface 106 may also provide a display to allow a user to view various data provided by the computing device 100. The user interface 106 may also be configured to provide a display of a graphical user interface (“GUI”), for example, GUI 116, which may be used by a user to provide inputs to the user interface 106, as well as display certain data to the user. In some embodiments, the electronic processor 108 may be configured to execute code from the memory 110 to generate the GUI 116 on the user interface 106. Additionally, the electronic processor 108 may be configured to receive and process inputs received via the GUI 116.

As described above, the memory 110 may be configured to store various processes, layers, and modules, which may be executed by the electronic processor 108 and/or the processing circuit 102. In one embodiment, the memory 110 may include one or more differential topic extraction applications 118. The differential topic extraction applications 118 may be configured to receive a dataset from the data center server 114 and/or the cloud server 112, analyze the dataset, and extract differential topics within the dataset, as will be described in more detail below. The differential topic extraction application 118 may include one or more sub-applications, such as a text to vector sub-application 120, a statistical analysis sub-application 122, and a classifier sub-application 124. The differential topic extraction application 118, and the associated sub-applications are discussed in more detail below.

The data center server 114 and the cloud server 112 are both shown to be in communication with one or more remote user workstations 130, 132 and one or more user device 134, 136. Remote user workstations 130, 132 may be computing devices similar to the computing device 100 described above. The remote user workstations 130, 132 may be used by multiple service personnel to input data related to issues or other comments received by users of one or more software packages. In one example, the remote user workstations 130, 132 are located at various call centers or service centers, where information received via customer service calls may be input into a database, such as the data center server 114 and/or the cloud server 112. In some embodiments, the cloud server 112 and the data center server 114 are configured to communicate with each other to update respective received data contained therein.

The user devices 134, 136 may allow a user to directly input data into the data center server 114 and/or the cloud server 112. The user devices 134, 136 may be personal computing devices, such as personal computers, laptop computers, smartphones, tablet computers, and the like. In one embodiment, a user may directly enter data into the user devices 134, 136, which is then communicated to the data center server 114 and/or the cloud server 112. For example, a user may input data via e-mail, web-entry, automatic feedback applications, etc. This can allow users to directly provide feedback about their use of a software program or package.

In other examples, the user devices 134, 136 may be other connected devices, such as smart speakers, voice assistants, and smart home device. These devices may upload data related to a software application that was presented to the connected devices. For example, a user may communicate to a connected device, such as a voice assistance, to obtain help or to provide voice feedback about a software package. In some embodiments, the connected device may be configured to automatically provide data to the data center server 114 and/or the cloud server 112. For example, the connected device may keep a list of terms that a user has spoken that were unable to be interpreted into commands or requests. These terms may be transmitted to the data center server 114 and/or the cloud server 112 for later analysis.

In one example, the differential topic extraction application 118 is configured to extract text stored in the cloud server 112 and/or the data center server 114. In one embodiment, the data is extracted based on one or more parameters, such as a specific software program, group of programs, products, topics, and the like. The differential topic extraction application 118 may then execute one or more sub-applications, as described herein. In one example, the differential topic extraction application 118 is configured to analyze data from two different geographical regions using the sub-applications to determine one or more topics that are region specific. In other examples, the differential topic extraction application 118 determines topics that are related to other discrete differentiators, such as languages, programs, market segments, products, etc.

While the differential topic extraction application 118 is shown as being stored within the memory 110 of the computing device 100, in some embodiments, the differential topic extraction application 118 is stored and/or processed in other devices or systems, for example the cloud server 112 and/or the data center server 114. In still other examples, one or more of the sub-applications, such as the text to vector sub-application 120, the statistical analysis sub-application 122, and the classifier sub-application 124 are separately located, for example in the data center server 114 and/or the cloud server 112, and communicate with the differential topic extraction application 118

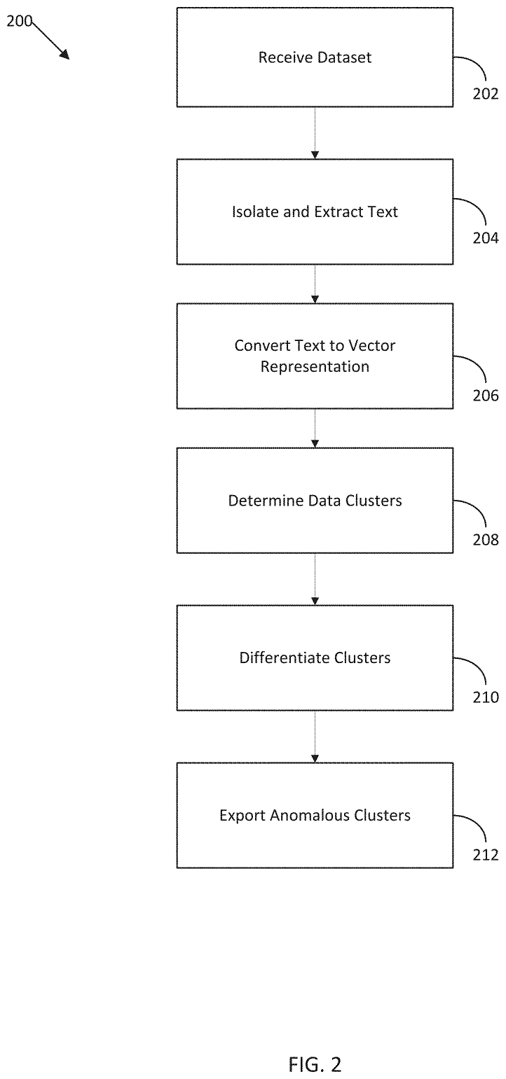

Turning now to FIG. 2, a flow chart illustrating a process 200 for performing differential topic extraction is shown. In one embodiment, the process is executed using one or more electronic processors, such as processing circuit 102 and/or processor 108 described above, configured to perform the actions and functions described herein. The one or more electronic processors are configured to analyze customer feedback to extract feedback that is region specific. For example, the differential topic extraction process 200 may determine regional specific issues such as Japanese users not liking the way date/time is displayed in a given software application when compared to English users. In general, the process 200 represents textual feedback data in a vector space, such as by using word embeddings. The vectored data is then clustered using one or more statistical analysis methods, and those clusters are then classified to determine specific clusters relevant to a specific region.

In other examples, the electronic processors may execute the process 200 in order to process data associated with smart speakers, voice assistants, and/or smart home devices (for example, connected devices). For example, the electronic processors may execute the process 200 to automatically find specific topics for different users based on an associated spoken command history when compared to other users and using those topics to inform a user about the topics. If a user is determined to be talking about a specific topic more than those in the general population, the process can extract those features that are more relevant to the user. In one embodiment, the process is specifically configured to determine difference between commands used by one subset of users versus another set of users, and provide this information to developers, which can then be used to drive feature decisions and product updates. For example, the electronic processors may execute the process 200 to find topics that users in New York are using their connected device for as opposed to users in San Francisco. In other examples, the electronic processors may execute the process 200 to determine certain topics that one age group interfaces with their connected devices as opposed to those in other age groups. In still other example, the electronic processors may execute the process 200 to determine topics that are discussed by users at a first time of day, as opposed to those discussed by users at a different time of day. In some examples, the electronic processors may execute the process 200 to determine which topics discussed by users are most underserved by the natural language understanding engine of the connected devices. Underserved topics are those topics that are talked about the most that cannot be understood by the connected devices.

In some examples, the electronic processors may execute the process 200 to analyze market research to identify trends within given populations, such as what topics are used by certain consumer segments (for example, teenagers) when searching in comparison to other consumer segments. In other examples, electronic processors may execute the process 200 to analyze social network data. As an example, the electronic processors may execute the process 200 to find specific themes in social media (for example, tweets, Facebook posts, etc.) that are more prevalent in one population more than in others. The specific themes may relate to what users are saying about one product or company that is different from what they say about other products or companies. The specific themes could also relate to political topics, and the electronic processors may execute the process 200 to find difference in different user's opinions about different candidates, based on factors such as user's location, user's age, user's political affiliations, etc.

The electronic processors may execute the process 200 to analyze customer success management (CSM) data. For example, the process 200 may determine what specific customers are discussing in regards to a product or service versus others. In other examples, electronic processors may execute the process 200 to analyze cloud computing data, such as how certain user segments use products within a cloud computing environment as compared to the use by other user segments.

At process block 202, a dataset is received by the differential topic extraction application 118 within the processing circuit 102. The differential topic extraction application 118 may initially request data from one or more databases, for example, the cloud server 112 and/or the data center server 114 described above. The received data may be related to the user of a software product, or other information as described above. As described above, the databases may receive data from one or more end user, such as via the remote user workstations 130, 132, and/or user devices 134, 136. In one embodiment, the differential topic extraction application 118 generates the request based on one or more definable parameters. In one example, the definable parameters are provided via the user interface 106. The definable parameters may include geographical boundaries, products, product versions (for example, software, hardware or firmware versions), user demographics, etc. The differential topic extraction application 118 then submits a query to the databases to obtain the datasets contained within the definable parameters. The service databases then return the relevant datasets to the differential topic extraction application 118 at block 202. As described above, the differential topic extraction application 118 communicates with the service databases and/or other data repositories using the communication interface 104.

At process block 204, the differential topic extraction application 118 isolates and extracts text from the received dataset. For example, the differential topic extraction application 118 removes all superfluous data from the dataset, such as images, punctuation, modification (for examples, bolding, italics, etc.) and the like using one or more isolation and extraction algorithms. Additionally, the differential topic extraction application removes or converts text with incorrect spelling. In some examples, the differential topic extraction application 118 assigns metadata to the extracted text to indicate the original positions of the words within the dataset, such that relationships between words in the extracted text can be determined. For example, the metadata includes the original position of the extracted text element within the dataset.

At process block 206, the differential extraction application 118 converts the text to vector data. In one embodiment, the text to vector sub-application 120 performs the conversion. The text may be converted into vector data and mapped within a high-dimensional space. For example, the vector data may be within a 300-dimensional space. However, in other embodiments, the high-dimensional space may be a less than 300-dimensional space, or a greater than 300-dimensional space.

In one embodiment, the text to vector sub-application 120 utilizes distributional semantic modeling to convert the text to semantic vector data. Distributional semantics modeling collects distributional information in high-dimensional vectors, and defines the distributional/semantic similarities in terms of vector similarity. The vector similarities may depend on the type of distributional information that is used to collect the vectors, such as topical similarities, paradigmatic similarities, and the like. Distributional semantics modeling may determine the vector data based on multiple parameters, for example, context type, context windowing, frequency weighting, dimensional reduction, similarity measures, and the like. Other conversion algorithms may also be used to convert the text to vector data, such as latent semantic analysis (LSA), Hyperspace Analogue to Language (HAL), syntax- or dependency-based models, random indexing, semantic folding, and topic modeling.

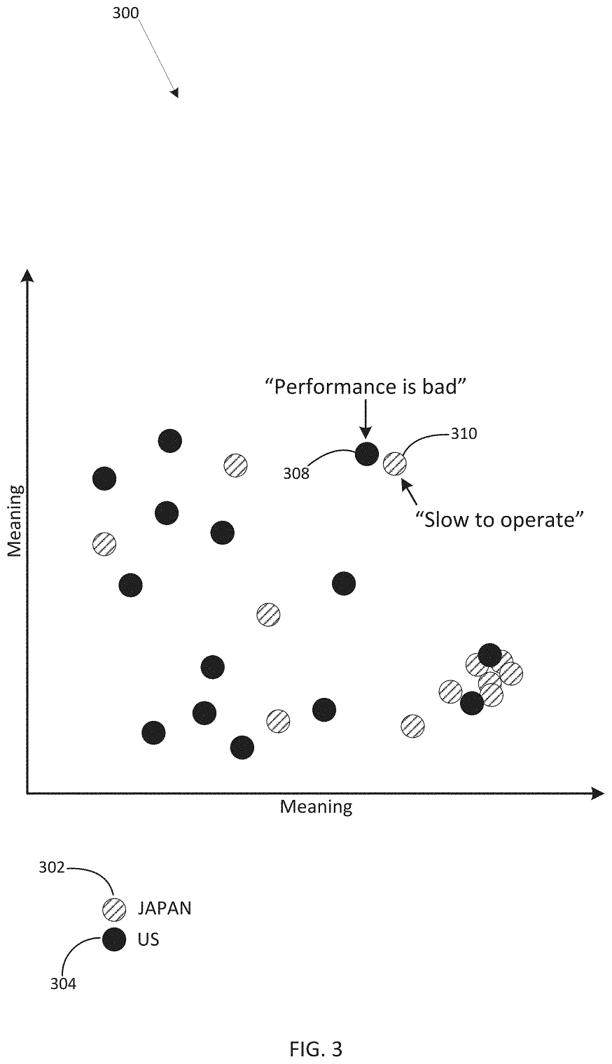

Turning now to FIG. 3, a representation of a high-dimensional vector space 300 of the converted vectors in high-dimensional space is shown, according to some embodiments. As shown in FIG. 3, the example text included US data 304 and Japanese data points 302. Each of the data points are plotted within the high-dimensional vector space 300. As described above, the text may be converted to vectors within the high-dimensional vector space 300 using semantic modeling. The semantic modeling may group similar text string near each other within the vector space 300. For example, US data point 308 may relate to a text string of “performance is bad,” and Japanese data point 310 may relate to a text string of “slow to operate.” As shown in FIG. 3, the data points 308, 310 are positioned relatively close to one another within the high-dimensional space 300 due to their similar meaning due to the semantic modeling being configured to group data points together that are semantically related or similar.

Returning now to FIG. 2, upon the text being converted to vector data, the process 200 determines data clusters at process block 208. In one embodiment, the differential extraction application 118 determines the data clusters. Alternatively, the statistical analysis sub-application 122 may determine the data clusters. In one embodiment, scan statistics, such as Bayesian scan statistics, may be used to determine data clusters within the vector data. The scan statistics analysis compares two or more topics (for example, semantic regions) within the vector data. Using the above example of evaluating American user data and Japanese user data, the topics used by the scan statistics analysis may be the American user data and the Japanese user data. After the text is converted to data vectors as described above, the statistical analysis sub-application 122 may use scan statistics analysis to determine topics that are being discussed more by one group than another (for example, by more Japanese users speaking about a given topic more than the American users). This allows the scan statistics to determine data clusters that are “anomalous,” meaning that they are more relevant to one “topic” than other clusters. In one embodiment, an anomalous “score” may be assigned for each data cluster.

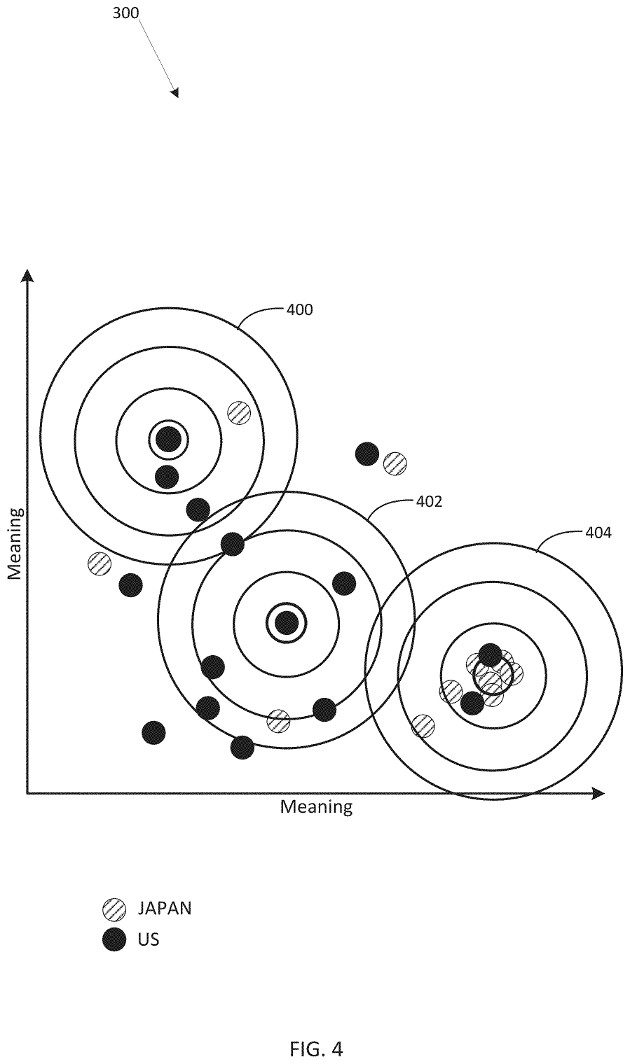

Turning now to FIG. 4, several anomalous regions 400, 402, 404 are shown within the vector space 300 described above. As described above, the anomalous regions may be determined by applying Bayesian scan statistics to the data within the vector space 300. In one embodiment, a Bayesian Gamma-Poisson model is used to determine the anomalous regions within the dataset. As described above, each anomalous region may be assigned a score that represents a level of anomalousness for each determined anomalous region. For example, the score may be a numerical value (for example, a statistical value) output from the Bayesian scan statistics analysis. While the above describes the use of Bayesian scan statistics, such as Bayesian Gamma-Poisson scan statistics, it is contemplated that other types of statistical analysis, including other types of scan statistics, may also be used to determine anomalous regions within a dataset.

Returning now to FIG. 2, electronic processors may execute the process 200 to differentiate the above determined data clusters at process block 210. In one embodiment, the differential extraction application 118 differentiates the data clusters. In other embodiments, the classifier sub-application 124 performs the differentiation. Differentiation of the data clusters may be required due to the overlap of multiple clusters within the high-dimensional space. This overlap can be seen in FIG. 4 between anomalous clusters 400, 402, 404. In one embodiment, only the data clusters with an anomalous score above a predefined threshold are differentiated. In other embodiments, only a select number of the data clusters are differentiated, based on their anomalous score. For example, the data clusters may be ranked based on their anomalous score described above. Based on the ranking, a select number, such as the top N data clusters are then differentiated. The N value may be five data clusters. In other embodiments, the N value is 50. In still other embodiments, the N value is 500 data clusters. Other N values are also contemplated.

By differentiating the data clusters, multiple anomalous data clusters can be evaluated to determine if they are referring to the same topic, or if they are referring to different topics. In one example, only those data clusters referring to the same topic are of interest. To differentiate the groups, multiple factors may be extracted. Example factors may include intersections (for example, the number of vectors in common for a given data cluster), similarity of the key terms, similarity of the center of the data clusters in terms of cosine similarity. The extracted features are then used as inputs to a classifier algorithm to de-correlate the data clusters. For example, a random forest classifier may be used to de-correlate the data clusters. Random forest classifiers are meta-estimators that fit a number of decision tree classifiers on various sub-samples of a dataset and generally use averaging to improve a predictive accuracy and control of over-fitting of the data. The output of the classifier algorithm determines if two data clusters are referring the same subject or not. The random forest classifiers use ensemble learning methods for classification and regression.

In some embodiments, the classifier algorithm may look at the rate of overlap between two data clusters. For example, 60% of data points within a first data cluster may also be present in a second nearby data cluster. The classifier algorithm may evaluate the similarity between the center points of both data clusters, as well as a distance (minimum, maximum, mean, median, etc.) between data points in each data cluster to determine how distant the two clusters actually are. Additionally, the classifier algorithm may evaluate the most frequent words in each of the data clusters. This data may all be used to determine whether the data clusters are related to the same topic. For example, if 8 of the top 10 most frequent data points are in each data cluster, it may be determined that the clusters are related to the same topic. By differentiating the data clusters, the classifier algorithm can ensure that different topics are extracted, and the similar topics are not incorrectly associated with each other. Conversely, data clusters that are referring to the same regions may be combined. In one embodiment, the classifier algorithm may be configured to differentiate regions that are related to a desired subset of data. For example, when the dataset includes US and Japanese data, a user may wish to differentiate out the anomalous regions that are most relevant to Japanese specific data.

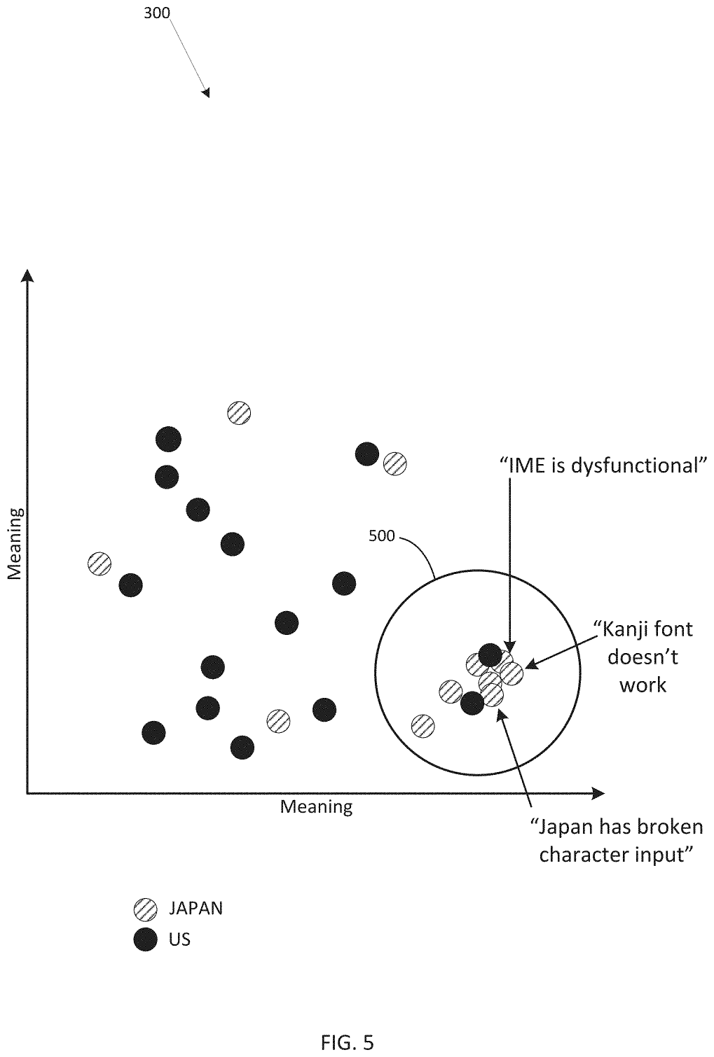

Turning now to FIG. 5, an example output of the differentiation of the anomalous clusters is shown, according to some embodiments. As shown in FIG. 5, cluster 500 is determined to be the most anomalous region based on the above differentiation. The cluster 500 includes data points such as “IME is dysfunctional,” “Kanji font doesn't work,” and “Japan has broken character input.” As further shown in FIG. 5, it is clear that there are substantially more Japanese data points in the cluster 500 than U.S. data points, thus indicating that the cluster 500 has a high “anomalous” score due to the disparity in the distribution of the data points.

Upon differentiating the clusters, the differentiated anomalous clusters are exported and provided to a user. In one embodiment, the differentiated anomalous clusters are provided to a user via the user interface 106 and/or via the GUI 116. In some embodiments, the differentiated anomalous clusters may be transmitted to a device of the user via the communication interface 104. The exported differentiated anomalous clusters may provide a summary of what topics are more relevant based on certain parameters. For example, again using the examples above, the exported differentiated anomalous clusters may provide a summary of topics that are more relevant to Japanese users, than to American users.

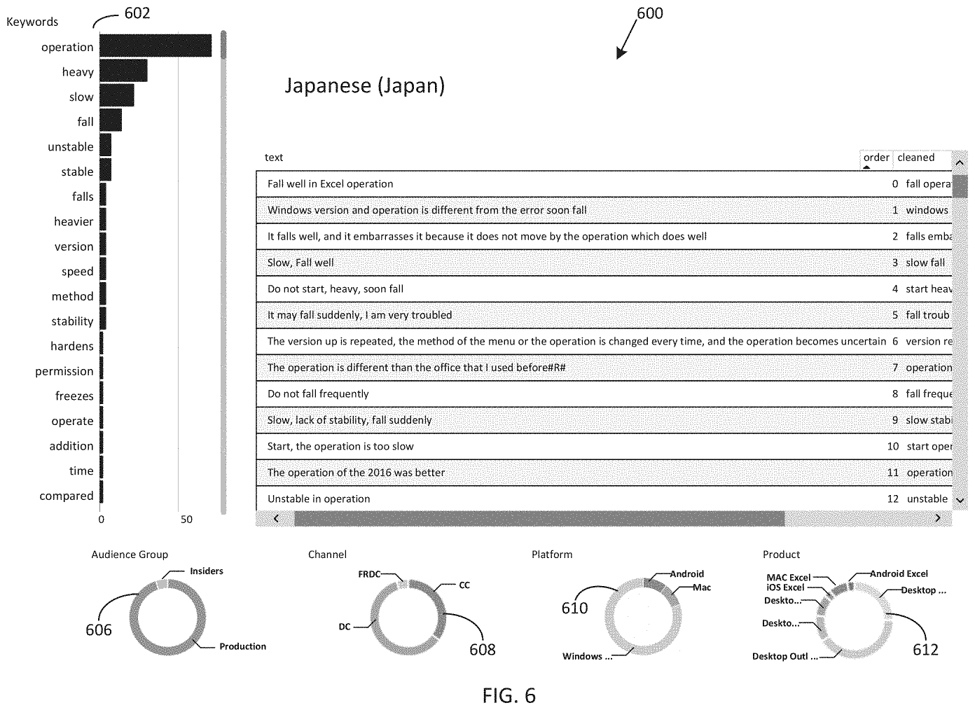

Turning now to FIG. 6, an example output display 600 provided to the user via the user interface 106 and/or the GUI 116 is shown. The display 600 may include a keyword frequency of occurrence plot 602. The keyword frequency of occurrence plot 602 may graphically illustrate the number of occurrences of keywords within a dataset. The example output display 600 may further include an expanded text display 604 for displaying a group of text data associated with the keywords. For example, as shown in FIG. 6, the most frequently occurring keyword is “operation,” and the expanded text display 604 is displaying various text strings from the dataset that include the keyword “operation.” As further shown in FIG. 6, other graphical displays different topic maps associated with the previously differentiated anomalous clusters. The topic maps may illustrate the frequency of occurrence of differentiated anomalous clusters within specific topical categories. For example, the display 600 may include an audience group topic map 606, a channel topic map 608, a platform topic map 610, and a product topic map 612.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the disclosure. Those skilled in the art will also appreciate that the features described above can be combined in various ways to form multiple implementations. As a result, the invention is not limited to the specific implementations described above.

What is claimed is:

1. A system for extracting differential topics from a dataset, the system comprising:
a user interface;
a memory for storing executable program code; and
one or more electronic processors coupled to the memory and the user interface, the electronic processors configured to:
receive a dataset from one or more servers, wherein the dataset comprises user feedback data associated with a software program;
extract text from the dataset;
convert extracted text to vector data;
determine anomalous data clusters associated with the vector data using statistical analysis;
differentiate overlapping anomalous data clusters using a classification algorithm, wherein the differentiated overlapping anomalous data clusters are associated with specific topics; and
export each specific topic associated with the differentiated overlapping data clusters.

2. The system of claim 1, wherein the servers receive data from users via a plurality of user devices.

3. The system of claim 2, wherein the user devices are voice assistant devices.

4. The system of claim 1, wherein the statistical analysis is a Bayesian scan statistical analysis.

5. The system of claim 1, wherein the statistical analysis is a Bayesian Gamma-Poisson statistical analysis.

6. The system of claim 1, wherein the classification algorithm is a forest classification algorithm.

7. The system of claim 1, wherein the electronic processors are configured to assign metadata to the extracted text.

8. The system of claim 7, wherein the assigned metadata comprises the original position of one or more extracted text elements within the dataset.

9. The system of claim 1, wherein the electronic processors are configured to map the vector data in high-dimensional space.

10. The system of claim 1, wherein the vector data is extracted using a distributional semantics modeling.

11. A method for extracting differential topics from a dataset, the method comprising:
receiving, at a computing device, a dataset from one or more servers, wherein the dataset comprises user feedback data associated with a software program;
extracting, via the computing device, text from the dataset;
converting, via the computing device, the extracted text to vector data within a high-dimensional vector space;
determining, via the computing device, anomalous data clusters associated with the vector data using statistical analysis;
differentiating, via the computing device, overlapping anomalous data clusters using a classification algorithm, wherein the differentiated overlapping anomalous data clusters are associated with specific topics within the user feedback data; and
exporting, via the computing device, each specific topic associated with the differentiated overlapping data clusters.

12. The method of claim 11, wherein the servers receive data from users via a plurality of user devices.

13. The method of claim 12, wherein the user devices are voice assistant devices.

14. The method of claim 11, wherein the statistical analysis is a Bayesian scan statistical analysis.

15. The method of claim 12, wherein the statistical analysis is a Bayesian Gamma-Poisson statistical analysis.

16. The method of claim 11, wherein the classification algorithm is a forest classification algorithm.

17. The method of claim 11, wherein the extracted text is converted to vector data by the electronic processing executing one or more distributional semantic modeling algorithms.

18. A system for extracting geographically differential topics from a dataset, the system comprising:
a user interface;
a memory for storing executable program code; and
one or more electronic processors coupled to the memory and the user interface, the one or more electronic processors configured to:
receive a dataset from one or more servers, wherein the dataset comprises user feedback data associated with a software program;
execute a differential topic extraction algorithm to isolate relevant text within the dataset;
extract text from the dataset;
convert extracted text to vector data by executing a distributional semantics modeling algorithm;
map the vector data in a high-dimensional space;
determine anomalous data clusters associated with the vector data using a Bayesian scan statistics statistical analysis;
differentiate overlapping anomalous data clusters using a classification algorithm, wherein the differentiated overlapping anomalous data clusters are associated with specific topics; and
export each specific topic associated with the differentiated overlapping data clusters.

19. The system of claim 18, wherein the classification algorithm is a forest classification algorithm.

20. The system of claim 18, wherein the Bayesian scan statistics statistical analysis is a Bayesian Gamma-Poisson statistical analysis.
